(19) United States
(12) Patent Application Publication
(10) Pub. No.: US 2007/0157808 A1
(43) Pub. Date: Jul. 12, 2007

(54) Filter with enhanced media area utilization

(76) Inventors: Brian K. Wagner, Stoughton, WI (US); Scott P. Heckel, Stoughton, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/327,614

(22) Filed: Jan. 6, 2006

(51) Int. Cl. B01D 46/00

(52) U.S. Cl. 95/273; 55/484

(57) ABSTRACT

A filter assembly has a plurality of filter elements extending longitudinally in a housing interior volume and shaped to increase filter media area by reducing unused space in the interior volume as compared to filter elements having a cylindrical shape.

### BACKGROUND AND SUMMARY

The invention relates to filter assemblies

Filters assemblies having a plurality of filter elements in a housing are known. The present invention arose during continuing development efforts related to such assemblies, including directed to longer filter life, higher capacity, and increased flow rate.

### BRIEF DESCRIPTION OF THE DRAWING

FIG. 1 is a sectional view of a filter assembly known in the prior art, taken along line 1-1 of FIG. 2.

FIG. 2 is a perspective view of the filter assembly of FIG. 1.

FIG. 3 is a sectional view of a filter assembly in accordance with the invention, taken along 3-3 of FIG. 4.

FIG. 4 is a perspective view of the filter assembly of FIG. 3.

### DETAILED DESCRIPTION

### Prior Art

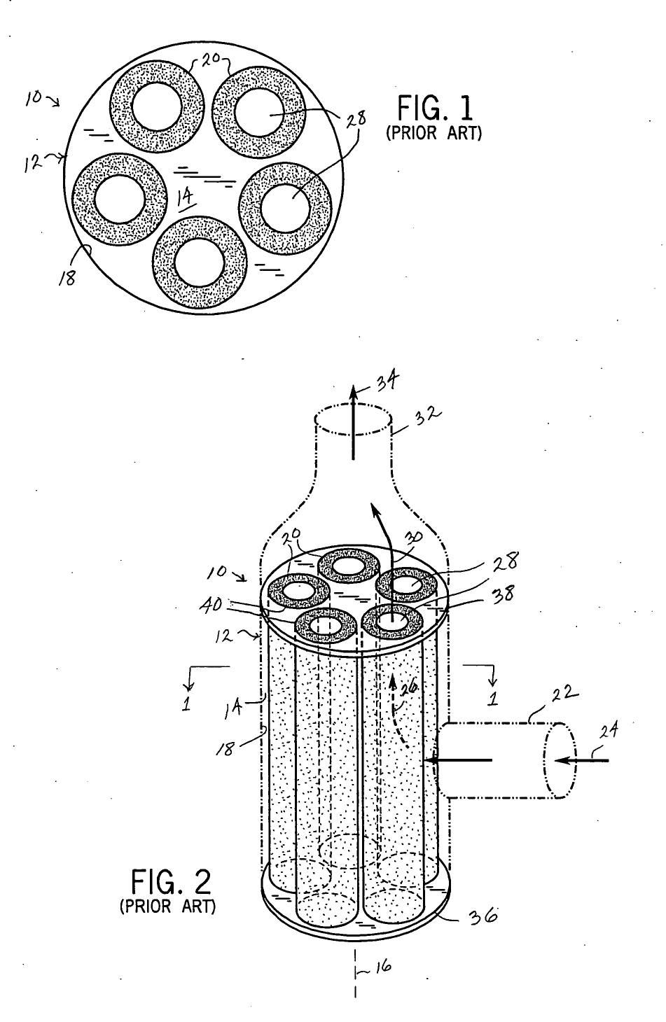

FIGS. 1 and 2 show a filter assembly 10 known in the prior art including a housing 12 having an interior volume 14 extending longitudinally along a longitudinal axis 16 and laterally bounded by a curvilinear perimeter at sidewall 18, e.g. a circular sidewall. A plurality of filter elements 20 extend longitudinally in interior volume 14 in housing 12. The housing has an inlet 22 receiving incoming fluid flow as shown at arrow 24, which fluid then flows as shown at arrow 26 through filter elements 20 into the hollow interiors 28 thereof and then flows axially as shown at arrow 30 for discharge at outlet 32 as shown at arrow 34. The housing has a lower end cap or plate 36 closing and sealing the bottom end of the housing and the bottom ends of filter elements 20. The housing has an upper end cap or plate 38 closing and sealing the upper end of the housing below outlet 32. Upper end cap 38 has a plurality of apertures 40 receiving the upper ends of filter elements 20 in sealing relation and providing the openings through which fluid flows at 30 from the upper ends of hollow interiors 28 of the filter elements. In other embodiments, the inlet may instead be provided at the lower end of the housing through a plurality of apertures in lower end cap 36 communicating with hollow interior 14. The depicted embodiment shows outside-in flow. The flow direction may be reversed, to provide inside-out flow, as is known.

### Present Application

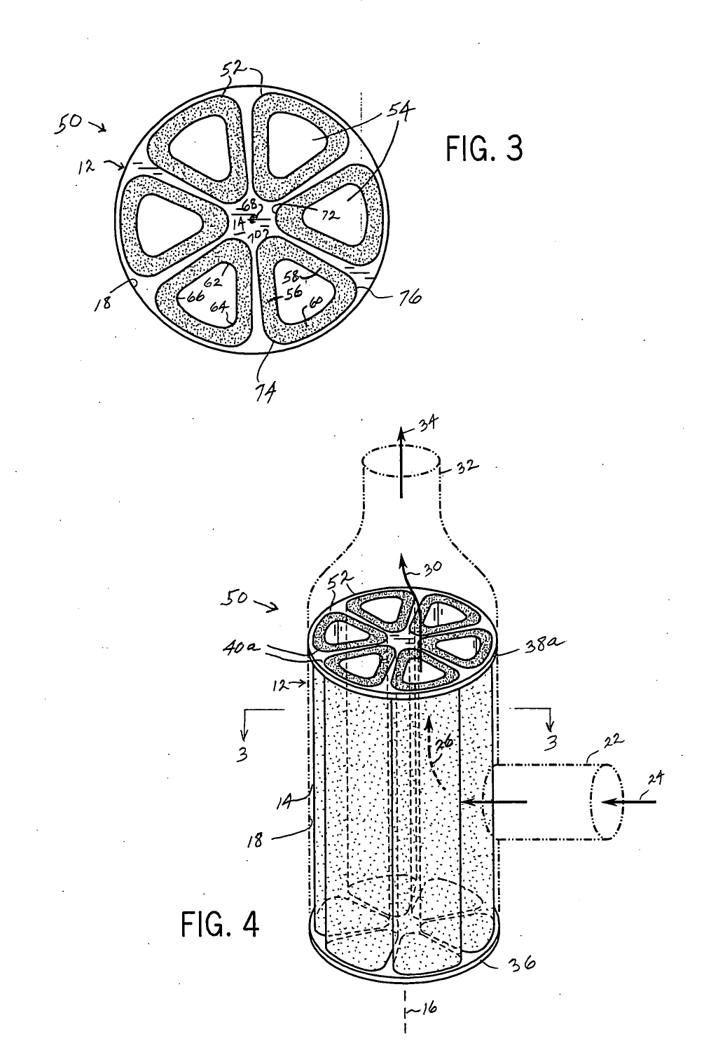

FIGS. 3 and 4 use like reference numerals from above where appropriate to facilitate understanding.

FIGS. 3 and 4 show a filter assembly 50 including housing 12 having interior volume 14 extending longitudinally along longitudinal axis 16 and laterally bounded by a curvilinear perimeter at sidewall 18, which perimeter may be circular, or other annular shape including oval shape, racetrack shape, or other closed- loop shape. A plurality of filter elements 52 extend longitudinally in interior volume 14 in housing 12 and are shaped to increase filter media area and reduce unused space in interior volume 14 as compared to cylindrical filter elements 20 of FIGS. 1, 2. In one embodiment, housing 12 is cylindrical, and filter elements 52 are non-cylindrical.

Each filter element is hollow as shown at hollow interiors 54, and in one embodiment has a wedge-shape, e.g. a pie-shape, in lateral cross-section. Each wedge-shape has three sides 56, 58, 60 forming three included angles 62, 64, 66 in a triangular shape. The three sides may be any combination of curvilinear (concave or convex) or rectilinear sides. In one embodiment, the three sides include two rectilinear sides 56, 58, and one curvilinear side 60. Housing 12 has a longitudinally extending centerline 68. Each wedge-shape has a wedge-apex 70 from which the pair of wedge-sides 56, 58 diverge radially outwardly. Each respective wedge-side faces a wedge-side of an adjacent wedge-shape. The wedge-apexes 70 define an inner perimeter 72 laterally circumscribing centerline 68. Wedge-sides 56, 58 diverge radially outwardly to respective wedge-tips 74, 76 spaced by an outer wedge-arc at 60 spanning arcuately therebetween and facing radially outwardly toward the noted outermost perimeter provided by housing sidewall 18. Lower end cap or plate 36 seals the bottom of the housing and the lower ends of hollow interiors 54, comparably to FIG. 2. Upper end cap or plate 38a is comparable to upper end cap 38 of FIG. 2 and closes and seals the upper end of the housing below outlet 32 and has apertures 40a comparable to apertures 40 except of triangular shape. The depicted embodiment shows outside-in flow. The flow direction maybe reversed, to provide inside-out flow.

The present system provides a method for increasing flow rate and filter life for a filter assembly by increasing the number of housed filter elements such as 52, by providing a housing 12 having an interior volume 14 extending longitudinally along longitudinal axis 16 and laterally bounded by a curvilinear perimeter at housing sidewall 18, providing a plurality of filter elements 52 extending longitudinally in interior volume 14 in housing 12, and shaping filter elements 52 to increase external element media area by reducing unused space in interior volume 14 as compared to cylindrical filter elements 20. The system provides increased media area within the same housing volume. This allows more filter media to be enclosed in the same housing volume. This in turn leads to longer filter life due to higher capacity. Furthermore, flow rates for given housing assemblies can be increased if the limiting factor was the amount of media inside the housing assembly. It is expected that various types of wedge-shapes maybe used for the filter elements to maximize usage of available space and to reduce unused space in interior volume 14. The preferred embodiment is especially effective with depth type filter elements, though other types of filter elements may be used, as well as various manufacturing techniques, including meltblowing onto a mandrel or core or extrusion or pleated versions. Desirable commercial implementations include liquid and gaseous filtration, e.g. lubricating oil, hydraulic oil, crankcase ventilation, natural gas filtration, fuel coalescers, and the like.

It is expected that various equivalents, alternatives and modifications are possible within the scope of the appended claims.

What is claimed is:

1. A filter assembly comprising a housing having an interior volume extending longitudinally along a longitudinal axis and laterally bounded by a perimeter, a plurality of filter elements extending longitudinally in said interior volume in said housing and shaped to increase filter media area by reducing unused space in said interior volume as compared to cylindrical filter elements.

2. The filter assembly according to claim 1 wherein said perimeter is curvilinear.

3. The filter assembly according to claim 1 wherein said filter elements are non-cylindrical.

4. The filter assembly according to claim 1 wherein said housing is cylindrical, and said filter elements are non-cylindrical.

5. The filter assembly according to claim 1 wherein each said filter element is hollow and has a wedge-shape in lateral cross-section.

6. The filter assembly according to claim 5 wherein each said wedge-shape has three sides forming three included angles in a triangular shape.

7. The filter assembly according to claim 6 wherein said three sides comprise a designated combination of curvilinear and rectilinear sides.

8. The filter assembly according to claim 7 wherein said curvilinear sides are selected from the group consisting of concave and convex.

9. The filter assembly according to claim 7 wherein said three sides comprise two rectilinear sides and one curvilinear side.

10. The filter assembly according to claim 5 wherein said housing has a longitudinally extending centerline, and each said wedge-shape has a wedge-apex from which a pair of wedge-sides diverge radially outwardly, each respective wedge-side facing a wedge-side of an adjacent wedge-shape, said wedge-apexes defining an inner perimeter laterally circumscribing said centerline.

11. The filter assembly according to claim 10 wherein said wedge-sides diverge radially outwardly to respective wedge-tips spaced by an outer wedge-arc spanning arcuately therebetween and facing radially outwardly toward said perimeter.

12. The filter assembly according to claim 5 wherein said wedge-shape is a pie-shape.

13. A method for increasing flow rate and filter life for a filter assembly by increasing the number of housed filter elements, comprising providing a housing having an interior volume extending longitudinally along a longitudinal axis and laterally bounded by a perimeter, and providing a plurality of filter elements 5 extending longitudinally in said interior volume in said housing, and shaping said filter elements to increase filter media area by reducing unused space in said interior volume as compared to cylindrical filter elements.
